(19) United States
(12) Patent Application Publication
(10) Pub. No.: US 2006/0015840 A1
(43) Pub. Date: Jan. 19, 2006

(54) Parameter-based software development, distribution, and disaster recovery

(76) Inventors: Wendall Marvel, Pittsburg, CA (US); Patrick Lo, Union City, CA (US); John James, San Mateo, CA (US); Mark Young, Belmont, CA (US); Russell Draper, Sunnyvale, CA (US); NeilFred Picciotto, Santa Clara, CA (US); Peter Vogel, Redwood City, CA (US)

Correspondence Address: SWERNOFSKY LAW GROUP PC, P.O. BOX 390013, MOUNTAIN VIEW, CA, 94039-0013, US

(21) Appl. No.: 11/096,216

(22) Filed: Mar. 30, 2005

Related U.S. Application Data
(60) Provisional application No. 60/557,965, filed on Mar. 31, 2004.

(51) Int. Cl. G06F 9/44

(52) U.S. Cl. 717/101; 717/124

(57) ABSTRACT

A method of developing a software product, including steps of: receiving sets of parameters (e.g., manifests) describing computing environments for a plurality of customers, at least some of said sets of parameters for some customers differing from others of said sets of parameters for other customers; receiving an indication from at least one of said customers of a bug or condition that occurs with said software product running under one of said sets of parameters; and testing said software product in a computing environment configured in accordance with said sets of parameters including at least said one of said sets of parameters indicated by said one of said customers. The sets of parameters can also be sent back to customers to help with disaster recovery. Also, a method of distributing said software product and servers that perform these methods.

### CROSS-REFERENCE TO RELATED APPLICATION

This application claims priority from and hereby incorporates by reference provisional application no. 60/557,965, filed Mar. 31, 2004, entitled “Advanced Software Application Packaging,” in the names of the same inventors.

### PATENT APPLICATION

This application is submitted in the name of the following inventors:

| Inventor | Citizenship | Residence City and State |
|---|---|---|
| Wendall MARVEL | United States | Pittsburg, California |
| Patrick LO | United States | Union City, California |
| John JAMES | United States | San Mateo, California |
| Mark YOUNG | United States | Belmont, California |
| Rusty DRAPER | United States | Sunnyvale, California |
| NeilFred PICCIOTTO | United States | Santa Clara, California |
| Peter VOGEL | United States | Redwood City, California |

The assignee is E2open, Inc., a corporation having an address in Redwood City, Calif.

### TITLE OF THE INVENTION

Parameter-Based Software Development, Distribution, and Disaster Recovery

### BACKGROUND OF THE INVENTION

1. Field of the Invention

This invention relates to software development, distribution, and disaster recovery that utilizes or restores parameters describing customers' computing environments.

2. Related Art

In most cases, software is designed to work in a particular general environment, for example a particular type of hardware running a particular operating system. However, many variations can exist within a particular general environment. Different customers running the same general hardware and operating system might have different amounts of memory and mass storage, different security and other software loaded onto the hardware, different configuration settings, and the like. In other cases, a particular software product or solution might be designed to work even across different general types of computing environments. Differences in parameters that define such general environments and variations of those environments (e.g., specific hardware, software, configuration setting, etc.) can significantly affect the operation of a particular piece of software.

The effects on the operation of the software can vary from different levels of performance to the occurrence of errors (i.e., “bugs”) such as system crashes. If a customer encounters unacceptable performance or an error, the customer might inform the software product's developer of the problem. However, if the developer does not have specific information about the parameters under which the software product was operating, the developer might not be able to recreate the problem. As a result, the developer might have a difficult time correcting or even verifying the existence of the problem.

Alternatively, the customer might report the problem to an intermediate party other than the developer. This party also might encounter these same problems while trying to assist the customer.

A variation of these problems occurs when a customer is recovering from a disaster. In particular, a customer's hardware and software may be functioning properly before being wiped out or otherwise degraded by some form of disaster, for example a power spike, physical damage to the hardware, a malicious program, or the like. The customer is then in the unenviable position of trying to completely rebuild those systems. Anyone who has tried to perform such a rebuild is aware that new problems often arise when trying to re-build systems and re-install software. These problems often occur because of changes in hardware, operating system, software and configuration settings that were lost in the disaster.

### SUMMARY OF THE INVENTION

Accordingly, what is needed are techniques for developing, testing and distributing software that account for variations of parameters in customers' hardware, software and configuration settings across similar general types of hardware and operating systems. The techniques also should provide a mechanism that accounts for these variations when assisting a customer with disaster recovery.

One embodiment of the invention is a method of developing a software product. This method includes at least the following steps: receiving sets of parameters describing computing environments for a plurality of customers, at least some of the sets of parameters for some customers differing from others of the sets of parameters for other customers; receiving an indication from at least one of the customers of a bug or condition that occurs with the software product running under one of the sets of parameters; and testing the software product in a computing environment configured in accordance with the sets of parameters including at least the set of parameters indicated by that customer. The software product can be modified in accordance with results of said step of testing and then distributed.

These steps allow a developer to verify and to reproduce more efficiently a bug or other condition reported by a customer. The steps also allow the developer to check to see if the bug or condition occurs under different parameters than those reported by the customer, which can aid in diagnoses and correction of the bug or condition. In some embodiments, the step of testing is performed automatically, thereby further increasing efficiency of this cross-parameter diagnosis.

The parameters also are available for other uses, for example to be returned to a customer in order to help that customer re-build their computing systems after a disaster.

Preferably, the sets of parameters are embodied in manifests that list a combination of one or more of a customer's hardware, software, and configuration settings. The step of testing preferably is performed automatically based on the sets of parameters. The manifests provide a uniform way for a developer to store hardware, software and configuration parameters for plural customers.

In some embodiments, the software product is distributed through an intermediate party. For example, a method that could be performed by such an intermediate party could include the following steps: configuring one or more servers in accordance with sets of parameters describing computing environments for a plurality of customers, at least some of the sets of parameters for some customers differing from others of the sets of parameters for other customers; receiving a software product from a developer for distribution to the customers; incorporating the software product into a software solution on the one or more servers; and distributing the software solution to the customers.

These steps create similar benefits for the intermediate party and customer as those discussed above. Furthermore, the intermediary can apply these benefits to development, testing, and distribution of complete software solutions that include one or more software products.

In some embodiments, the intermediate party receives the sets of parameters from customers. In other embodiments, the servers used by the intermediate party are cloned from servers used by the software product's developer. This cloning process permits the developer to maintain tighter control over conditions under which their products are developed and tested. This tighter control can help ensure that the developer and the intermediate party are operating in common environments, thereby helping to avoid problems that could occur as a result of different environments. For example, if the intermediate party had a different set of parameters for customers than the developer, the intermediate party might encounter bugs and other conditions that the developer is not aware of or cannot reproduce. Use of a common environment can help to avoid this problem.

Because the intermediate party also has customers' parameters on hand, the intermediate party also can aid customers with disaster recovery.

The invention also encompasses apparatuses and software products that implement the foregoing methods.

This brief summary has been provided so that the nature of the invention may be understood quickly. A more complete understanding of the invention may be obtained by reference to the following description of the preferred embodiments thereof in connection with the attached drawings.

### BRIEF DESCRIPTION OF THE FIGURES

FIG. 1 illustrates use of hardware, software and configuration parameters using manifests according to an embodiment of the invention.

FIG. 2 illustrates a software product development and distribution system according to an embodiment of the invention.

FIG. 3 is a flowchart of software product development and distribution according to an embodiment of the invention.

FIG. 4 is a flowchart of software solution development and distribution by an intermediate party according to an embodiment of the invention.

FIG. 5 is a flowchart of disaster recovery using manifests according to an embodiment of the invention.

### DESCRIPTION OF THE PREFERRED EMBODIMENT

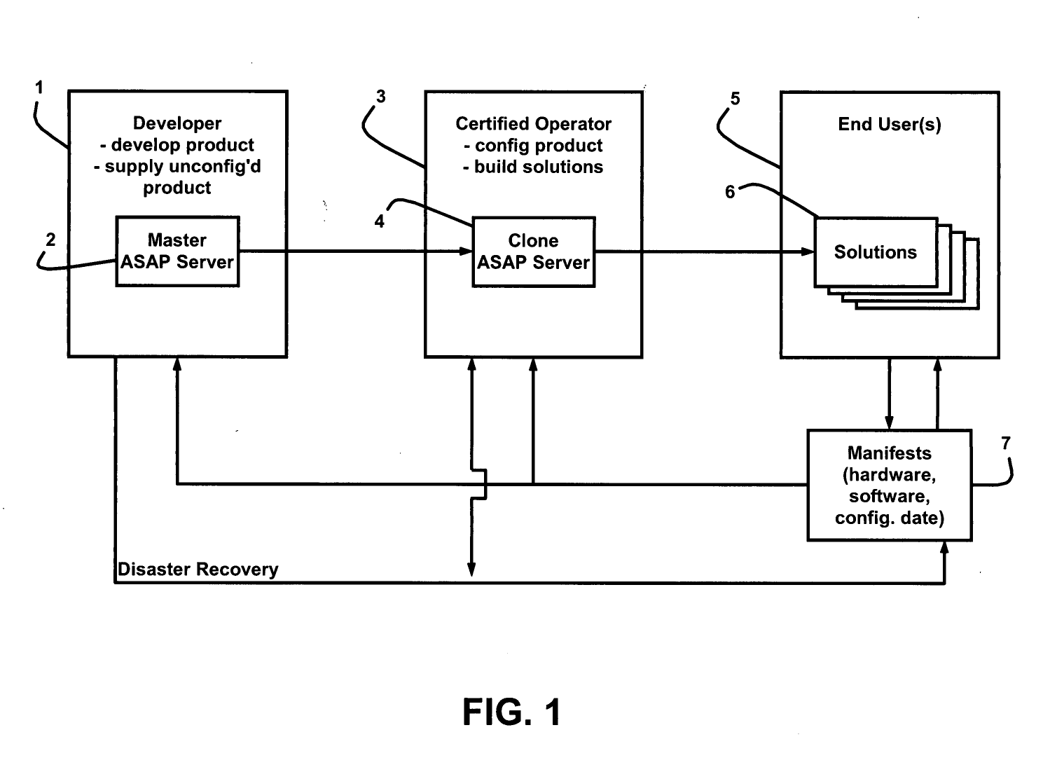

FIG. 1 illustrates use of hardware, software and configuration parameters using manifests according to an embodiment of the invention.

Developer 1 in FIG. 1 develops a software product, for example an application program or tool. In the embodiment shown in FIG. 1, the product is not configured. The product preferably is stored on master advanced software application packaging (ASAP) server 2. The developer can have plural of these ASAP servers.

Certified operator 3 is an intermediate party that is certified by developer 1 to deliver the software product to end user(s) 5 (i.e., customers), either as a standalone product or as part of one or more overall software solution(s) 6. In a preferred embodiment, certified operator 3 has clone ASAP server 4, which is a clone of one or more of developer 1's master ASAP server(s). The clone preferably is updated periodically, either manually or automatically. These updates can be “pull” updates in which the certified operator requests the update or “push” updates in which the developer promotes the update to the certified operator.

Use of a clone by certified operator 3 permits developer 1 to maintain tighter control over conditions under which their products are developed and tested. This tighter control can help ensure that the developer and the certified operator are operating in common environments, thereby helping to avoid problems that could occur as a result of different environments. For example, if the certified operator had a different set of parameters for customers than the developer, the certified operator might encounter bugs and other conditions that the developer is not aware of or cannot reproduce. Use of a common environment can help to avoid this problem.

Alternatively, developer 1 could directly deliver the software product or solutions to end user(s) 5.

In most cases, each software product or solution is designed to work in a particular general environment. For example, a software product might be designed to run on an Intel® or Apple® computer under the Windows® XP operating system. However, many variations can exist within a particular general environment. Different end users running the same general hardware and operating system might have different amounts of memory and mass storage, different security and other software loaded onto the hardware, different configuration settings, and the like. In other cases, a particular software product or solution might be designed to work even across different general types of computing environments. Differences in parameters that define such general environments and variations of those environments (e.g., specific hardware, operating system, software, configuration setting, etc.) can significantly affect the operation of a particular piece of software.

In order to permit the developer to account for these differences, end user(s) 5 supply manifests 7 to developer 1. An end user's manifest specifies parameters such as one or more of particular hardware, operating system, software and configuration data for the computing environment used by the end user. The manifests can be generated manually by the end user(s) or automatically, for example using a software tool provided to the end user(s). The developer can use the information in manifests from its end users to test its software product, thereby helping to reduce bugs and performance problems.

If bugs, performance problems or other special conditions are encountered by an end user, the end user can report the bug or condition to the developer. The developer can then examine the manifest for the customer in order to help track down any parameters that might be related to the bug or condition. In addition, the developer can use the manifest to configure a test system identically or close to the computing environment under which the bug or error was encountered. This process can be performed manually or automatically. In either case, the use of the manifests can help the developer to confirm and develop a remedy (if needed) for the bug or condition.

The developer also can check to see if the bug or condition occurs under different parameters than those reported by the customer. This operation can aid in diagnoses and correction of the bug or condition. The cross-parameter testing can be performed automatically or manually. In a preferred embodiment, automatic cross-parameter testing further increases efficiency of the testing process.

Certified operator 3 can also benefit from use of the manifests in a similar manner.

The manifests can be useful even in the absence of bugs or other special conditions. A customer's hardware and software may be functioning properly before being wiped out or otherwise degraded by some form of disaster, for example a power spike, physical damage to the hardware, a malicious program, or the like. The customer is then in the unenviable position of trying to completely rebuild those systems. Anyone who has tried to perform such a rebuild is aware that new problems often arise when trying to re-build systems and re-install software. These problems often occur because of changes in hardware, operating system, software and configuration settings that were lost in the disaster. The developer and/or certified operator can provide a customer with their manifest to help them avoid or identify such changes.

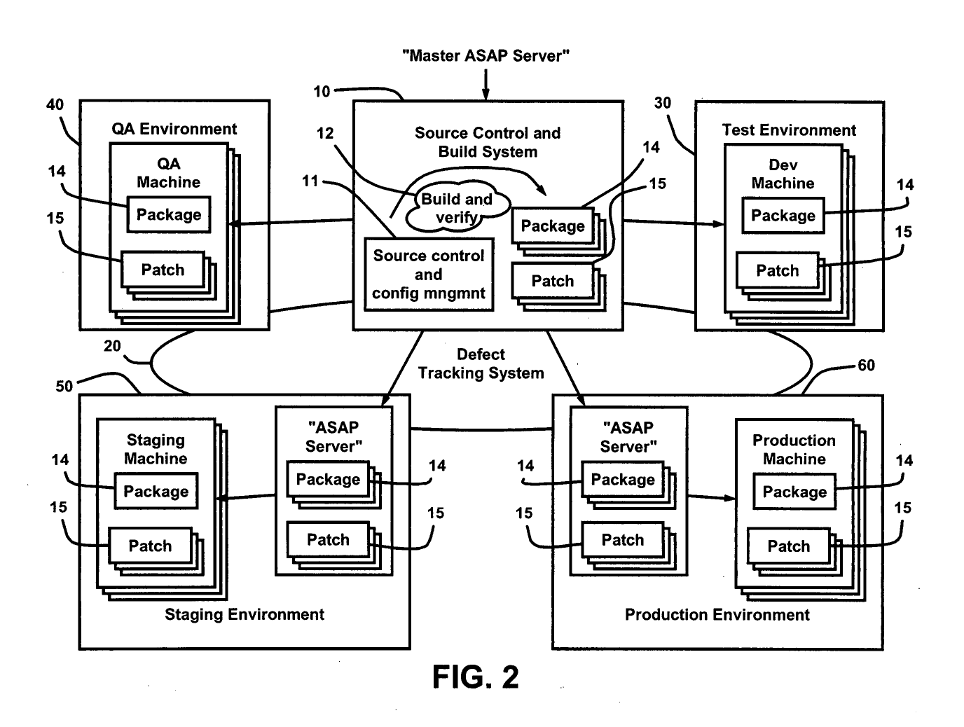

FIG. 2 illustrates a software product development and distribution system according to an embodiment of the invention.

In FIG. 2, each of the environments is provided with parameters describing computing environments for a plurality of customers (i.e., end users), preferably in a form of manifests or data compiled from customer's manifests. Each of the machines and servers in those environments can benefit from these parameters as discussed above.

Source control and build system 10 in FIG. 2, which preferably resides on a master ASAP server, coordinates development, testing, quality assurance (QA), staging, and production of a software product. This system comprises two entities, namely a source control and configuration management system and a build process.

Source control and configuration management system 11 preferably is built on top of Rational's ClearCase® in conjunction with the Unified Change Management process. At a high level the artifacts within this system are organized into projects. These projects are further broken down into various sub-components. Within projects different development “branches” allow for simultaneous activities on the same components.

Build process 12 is tightly integrated with the source control and configuration management system. An automated process regularly builds all of the projects within the source control system and verifies the result of this build by deploying and unit testing the results. Once verified the results of this build are made available for consumption by the development and QA environments. The build process produces two types of artifacts: packages 14 and patches 15.

Packages 14 are roughly equal in concept to a UNIX package except that they have been generalized to be deployable across multiple operating systems (UNIX variants, Windows, etc.). Packages can contain nearly any collection of related files including developed applications, third-party applications, configuration modules, test modules, etc. Packages can depend upon and/or overlay other packages. For example, it is possible to package something like an SCPM Cluster and deploy that Cluster onto an existing SCPM instance.

Patches 15 are basically “sparse packages”. They are used in cases where the creation of an entire package is too cumbersome in relation to the actual changes being made. For example, a two-line change to a configuration file would be deployed via a patch whereas an update to a third-party application would be deployed as a package. Patches are dependent upon the package that they update.

Defect tracking system 20 preferably is based on Rational's ClearQuest® product. All bugs and issues (whether occurring in QA, staging, or production) should be entered into and tracked by this system. Incidents within the system follow a workflow as the issue is analyzed and a resolution determined. Certain activities within the Source Control and Build system must be correlated with incidents within the defect tracking system. For example, it is generally impossible to check a file into a branch corresponding to a package that has been deployed to the staging or production environments unless you have an incident number to correlate the submission against. This facilitates goals of accountability and closed-loop problem resolution.

Test environment 30 is a computing environment that includes a set of machines and resources for use by engineers to test and to debug applications and services. The types of machines and resources in the test environment coincide with at least a subset of those with which the software product can or will be used, or at least with machines and resources that can simulate such.

The packages and patches used in test environment 30 are usually pulled directly from source control and build system 10. When performing mainline development and engineer will generally pull the latest verified versions of the packages and patches that they are working with. When debugging a problem or performing regression tests on a component in staging or production, an engineer will typically pull the packages that are built from the source-control branch corresponding to the system that they are debugging.

Quality assurance (QA) environment 40 is a set of machines and resources for use by engineers to run QA tests against the changes produced by development. Like development the packages and patches used by QA are pulled directly from source control and build system 10.

Staging environment 50 is a set of machines and resources for use by engineers to perform integration and acceptance tests with business partners. The staging environment can be thought of as a pre-production environment. For these reason, the packages and patches deployed within the staging environment are controlled through an intermediate ASAP Server. Unlike test and QA machines, the machines within the staging environment pull their packages and patches from a specifically designated ASAP Server. Packages are pushed from source control and build system 10 by a process known as promoting. After a given software or configuration change has been developed, regression tested and run through the QA process that change will be promoted to staging when the interested parties (development, QA, and customer support) agree that there is no more testing that could be done and no know issues that would impact the successful deployment and operation of the components affected by this change.

Like the staging environment, production environment 60 is protected by an intermediate ASAP Server. Packages and patches are promoted to production only after they have passed all other regression, QA, and staging tests. Like promotion to staging, promotion to production should require sign-off by the necessary parties. Unlike staging, deployment of packages and patches within production can only occur during pre-defined maintenance windows.

While the various elements of the software product development and distribution system shown in FIG. 2 are well suited to benefit from information about parameters of customers' computing environments, the invention is not limited to that system. Rather, the invention is equally applicable to any development and distribution system in which parameter information about customers' computing environments could be useful.

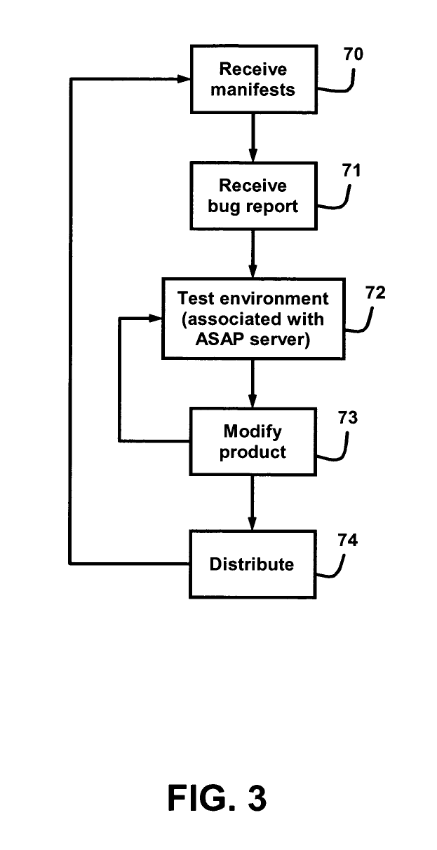

FIG. 3 is a flowchart of software product development and distribution according to an embodiment of the invention.

Briefly, one embodiment of the invention is a method of developing a software product. The method includes steps of receiving sets of parameters describing computing environments for a plurality of customers, at least some of said sets of parameters for some customers differing from others of said sets of parameters for other customers; receiving an indication from at least one of said customers of a bug or condition that occurs with said software product running under one of said sets of parameters; and testing said software product in a computing environment configured in accordance with said sets of parameters including at least said one of said sets of parameters indicated by said one of said customers.

In more detail, a developer of a software product receives sets of parameters describing computing environments for a plurality of customers in step 70. These sets of parameters preferably are embodied in manifests that list a combination of one or more of a customer's hardware, operating system, software and configuration settings. At least some of said sets of parameters for some customers differ from others of said sets of parameters for other customers.

Preferably, the parameters from the manifests are used to help develop and test the software product. In the context of a system such as the one shown in FIG. 2, the parameters can be provided to some or all of the various environments and servers that make up the system. The parameters could be provided directly, or data extracted from the parameters could be provided. In other contexts, the parameters could be provided to whatever servers or environments the developer is using to develop and to test their software product.

In step 71, the developer receives an indication from at least one of their customers of a bug or condition that occurs with the software product running under one of the sets of parameters. For example, the customer could submit a “bug report” to the developer, perhaps via e-mail or an automatic bug reporting tool in the product.

The developer can then test the software product in step 72. The product preferably is tested in a test environment associated with the ASAP server(s) for the software product. At least part of the test environment preferably is configured in accordance with the set of parameters that correspond to the parameters under which the customer experienced the bug or other condition. The configuration and testing can be performed manually or automatically.

In step 73, the software product can be modified, if needed, based on a result of the testing. Modification can be performed through any suitable method, including patches and packages as discussed above with respect to FIG. 2.

These steps allow a developer to verify and to reproduce more efficiently a bug or other condition reported by a customer. The steps also allow the developer to check to see if the bug or condition occurs under different parameters than those reported by the customer, which can aid in diagnoses and correction of a cause for the bug or condition. In some embodiments, the step of testing is performed automatically, thereby further increasing efficiency of this cross-parameter diagnosis.

If necessary, steps 73 and 74 preferably can be repeated until the bug or condition experienced by the customer is addressed.

The software product or updates to the software product are distributed in step 74, either directly to customers or through an intermediate party. In some embodiments, updates can be distributed through patches or packages. Other techniques of distributing the software product and updates can be used.

After distribution of the product or updates, the entire process can be repeated in order to further develop, debug, improve or otherwise update the software product.

While the foregoing steps have been discussed in the context of a developer and customer (i.e., end user), the same type of process can be used by an intermediate party such as a certified operator when developing a software solution for a customer from one or more software products.

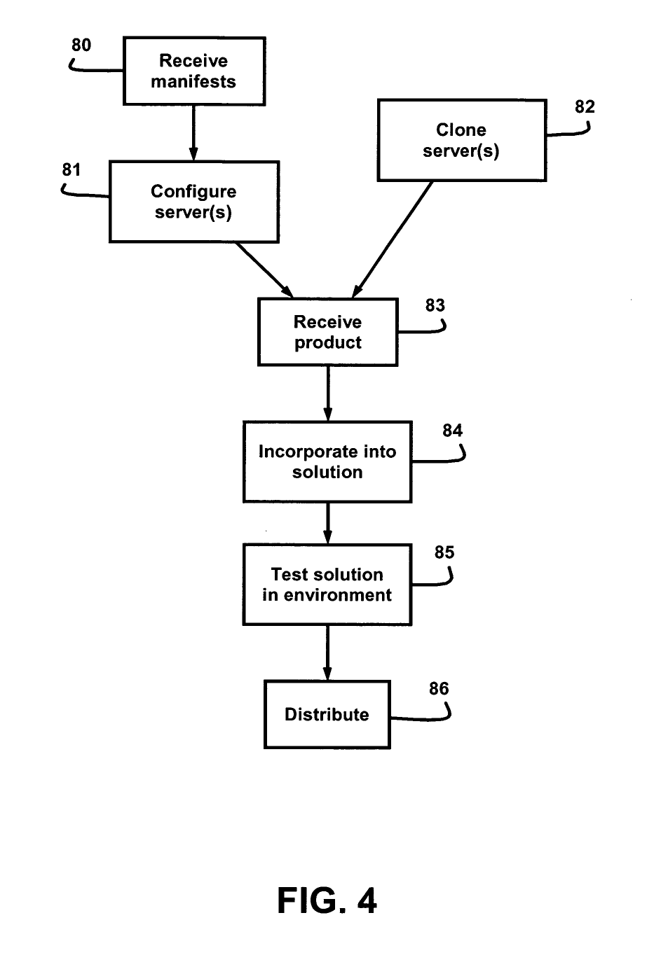

FIG. 4 is a flowchart of software solution development and distribution by an intermediate party (e.g., certified operator) according to an embodiment of the invention.

Briefly, one embodiment of the invention is a method of distributing a software product, for example as part of a software solution for a customer. The method includes steps of configuring one or more servers in accordance with sets of parameters describing computing environments for a plurality of customers, at least some of the sets of parameters for some customers differing from others of the sets of parameters for other customers; receiving a software product from a developer for distribution to the customers; incorporating the software product into a software solution on the one or more servers; and distributing the software solution to the customers.

In more detail, an intermediate party between a developer and a customer for a software product configures their server(s) in steps 80 to 82. Two different techniques for configuring the server(s) are shown. Both techniques configure the server(s) in accordance with sets of parameters describing computing environments for a plurality of customers. At least some of the sets of parameters for some customers differ from others of the sets of parameters for other customers.

In the first technique, the intermediate party receives the parameters from customers, for example in manifests. The intermediate party then configures their server(s) in accordance with these parameters. These operations are shown as steps 80 and 81 in FIG. 4.

In the second technique, the intermediate party clones server(s) from one or more servers used by the software product's developer. This cloning process permits the developer to maintain tighter control over conditions under which their products are developed and tested. This tighter control can help ensure that the developer and the intermediate party are operating in common environments, thereby helping to avoid problems that could occur as a result of different environments. For example, if the intermediate party had a different set of parameters for customers than the developer, the intermediate party might encounter bugs and other conditions that the developer is not aware of or cannot reproduce. Use of a common environment can help to avoid this problem. The cloning process is shown as step 82 in FIG. 4.

The intermediate party receives a software product or updates to a software product for distribution in step 83. In step 84, the intermediate product can incorporate the software product into an overall software solution for a customer. Development of the software solution could involve, for example, configuring the software product for the customer, incorporating the software product with other products such as hardware and other software, and the like. Alternatively, the intermediate party might simply distribute the software product as a solution without any changes.

The developer can test the software solution in step 85. Because the intermediate party's server(s) are configured in accordance with sets of parameters describing computing environments for customers, this testing should be effective to detect bugs and other conditions likely to be encountered by the customers. The software solution can be updated or modified as needed based on this testing.

The software solution or updates to the software solution is distributed to customers in step 86.

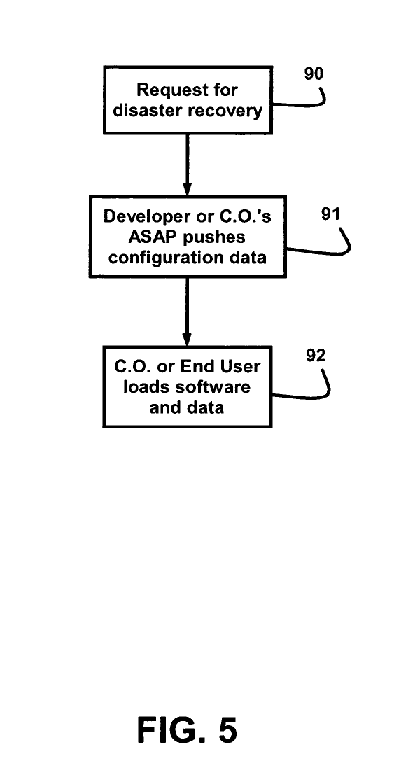

FIG. 5 is a flowchart of disaster recovery using manifests according to an embodiment of the invention.

Briefly, the usefulness of the parameter information discussed above is not limited to development, testing and distribution of software products and solutions. Instead, this information—particularly if embodied as manifests or data derived from such manifests—can be useful for helping customers to recover from disasters.

For example, a customer's hardware and software may be functioning properly before being wiped out or otherwise degraded by some form of disaster, for example a power spike, physical damage to the hardware, a malicious program, or the like. The customer is then in the unenviable position of trying to completely rebuild those systems. Anyone who has tried to perform such a rebuild is aware that new problems often arise when trying to re-build systems and re-install software. These problems often occur because of changes in hardware, operating system, software and configuration settings that were lost in the disaster. The developer and/or certified operator can provide a customer with their manifest to help them avoid or identify such changes.

Prior the steps shown in FIG. 5, a customer has provided parameter information regarding their computing environment to a developer or an intermediate party. The parameter information can be embodied in, for example, a manifest of the customer's hardware, operating system, software and configuration setting. Then, a disaster or event has occurred that has forced the customer to rebuild, recover or reconfigure their computing environment.

In step 91, a customer sends a request for assistance with disaster recovery to a developer or intermediate party. This request includes or serves as a request for a set of parameters describing the customer's computing environment.

The developer or intermediate party (e.g., certified operator) sends or pushes the parameters back to the customer in step 92. The set of parameters can be embodied in a manifest that lists a combination of one or more of the customer's hardware, operating system, software and configuration settings. In a preferred embodiment, an ASAP server at the developer or intermediate party performs this operation automatically.

The intermediate party or customer uses this parameter information to help recover from the disaster in step 93, for example by loading and configuring the customer's hardware and software. In one embodiment, the intermediate party can perform some or all of step 93 remotely, for example over the Internet. In a preferred embodiment, the configuration is performed automatically based on the manifest.

The steps if FIGS. 3 to 5 preferably are executed in the order shown. However, the invention also encompasses embodiments in which the steps are executed in different orders, where possible, and in different arrangements, for example in parallel.

### Alternative Embodiments

In the preceding description, preferred embodiments of the invention are described with regard to preferred process steps and data structures. However, those skilled in the art would recognize, after perusal of this application, that embodiments of the invention may be implemented using one or more general purpose processors or special purpose processors adapted to particular process steps and data structures operating under program control, that such process steps and data structures can be embodied as information stored in or transmitted to and from memories (e.g., fixed memories such as DRAMs, SRAMs, hard disks, caches, etc., and removable memories such as floppy disks, CD-ROMs, data tapes, etc.) including instructions executable by such processors (e.g., object code that is directly executable, source code that is executable after compilation, code that is executable through interpretation, etc.), and that implementation of the preferred process steps and data structures described herein using such equipment would not require undue experimentation or further invention.

Furthermore, the invention is in no way limited to the specifics of any particular embodiments and examples disclosed herein. For example, the terms “preferably,” “preferred embodiment,” “one embodiment,” “this embodiment,” “alternative embodiment,” “alternatively” and the like denote features that are preferable but not essential to include in embodiments of the invention. Many other variations are possible which remain within the content, scope and spirit of the invention, and these variations would become clear to those skilled in the art after perusal of this application.

What is claimed is:

1. A method of developing a software product, comprising the steps of:
receiving sets of parameters describing computing environments for a plurality of customers, at least some of said sets of parameters for some customers differing from others of said sets of parameters for other customers;
receiving an indication from at least one of said customers of a bug or condition that occurs with said software product running under one of said sets of parameters; and
testing said software product in a computing environment configured in accordance with said sets of parameters including at least said one of said sets of parameters indicated by said one of said customers.

2. A method as in claim 1, wherein said sets of parameters are embodied in manifests that list a combination of one or more of a customer's hardware, operating system, software and configuration settings.

3. A method as in claim 1, wherein said step of testing is performed automatically by a server based on said sets of parameters.

4. A method as in claim 1, further comprising the step of sending one of said sets of parameters to one of said customers to assist with disaster recovery.

5. A method as in claim 1, further comprising the step of distributing said software product to said customer.

6. A method as in claim 5, further comprising the step of modifying said software product in accordance with results of said step of testing before said software product is distributed.

7. A method as in claim 6, wherein said software product is modified through one or more patches or packages.

8. A method as in claim 5, wherein said software product is distributed through an intermediate party.

9. A method of distributing a software product, comprising the steps of:
configuring a computing environment in accordance with sets of parameters describing computing environments for a plurality of customers, at least some of said sets of parameters for some customers differing from others of said sets of parameters for other customers;
receiving a software product from a developer for distribution to said customers;
incorporating said software product into a software solution on said one or more servers; and
distributing said software solution to said customers.

10. A method as in claim 9, wherein said software solution includes one or more other software products.

11. A method as in claim 10, further comprising the step of testing said software solution in said computing environment.

12. A method as in claim 9, wherein said sets of parameters are received from said customers.

13. A method as in claim 9, wherein said one or more servers are cloned from one or more of said developer's servers.

14. A method as in claim 9, further comprising the step of sending one of said sets of parameters to one of said customers to assist with disaster recovery.

15. A method of disaster recovery, comprising the steps of:
requesting a set of parameters describing a customer's computing environment from an entity to whom said set of parameters had been sent before said disaster;
receiving said set of parameters;
configuring said customer's computing environment in accordance with said set of parameters.

16. A method as in claim 15, wherein said set of parameters is embodied in a manifest that lists a combination of one or more of said customer's hardware, operating system, software and configuration settings.

17. A method as in claim 15, wherein said step of configuring is performed automatically based on said sets of parameters.

18. A server, comprising:
a processor;
mass storage and memory that store data and instructions, said instructions executable by the processor and including step of:
receiving sets of parameters describing computing environments for a plurality of customers, at least some of said sets of parameters for some customers differing from others of said sets of parameters for other customers;
receiving an indication from at least one of said customers of a bug or condition that occurs with said software product running under one of said sets of parameters; and
testing said software product in a computing environment configured in accordance with said sets of parameters including at least said one of said sets of parameters indicated by said one of said customers.

19. A server as in claim 18, wherein said sets of parameters are embodied in manifests that list a combination of one or more of a customer's hardware, operating system, software and configuration settings.

20. A server as in claim 18, wherein said step of testing is performed automatically by a server based on said sets of parameters.

21. A server as in claim 18, wherein said instructions further comprise the step of sending one of said sets of parameters to one of said customers to assist with disaster recovery.

22. A server as in claim 18, wherein said instructions further comprise the step of distributing said software product to said customer.

23. A server as in claim 22, wherein said instructions further comprise the step of modifying said software product in accordance with results of said step of testing before said software product is distributed.

24. A server as in claim 23, wherein said software product is modified through one or more patches or packages.

25. A server as in claim 22, wherein said software product is distributed through an intermediate party.

26. A server, comprising:
a processor;
mass storage and memory that store data and instructions, said instructions executable by the processor and including step of:
configuring a computing environment in accordance with sets of parameters describing computing environments for a plurality of customers, at least some of said sets of parameters for some customers differing from others of said sets of parameters for other customers;
receiving a software product from a developer for distribution to said customers;
incorporating said software product into a software solution on said server; and
distributing said software solution to said customers.

27. A server as in claim 26, wherein said software solution includes one or more other software products.

28. A server as in claim 27, wherein said instructions further comprise the step of testing said software solution in said computing environment.

29. A server as in claim 26, wherein said sets of parameters are received from said customers.

30. A server as in claim 26, wherein said server is cloned from one of said developer's servers.

31. A server as in claim 26, wherein said instructions further comprise sending one of said sets of parameters to one of said customers to assist with disaster recovery.

32. A server, comprising:
a processor;
mass storage and memory that store data and instructions, said instructions executable by the processor and including step of:
requesting a set of parameters describing a customer's computing environment from an entity to whom said set of parameters had been sent before said disaster;
receiving said set of parameters;
configuring said customer's computing environment in accordance with said set of parameters.

33. A server as in claim 32, wherein said set of parameters is embodied in a manifest that lists a combination of one or more of said customer's hardware, operating system, software and configuration settings.

34. A server as in claim 32, wherein said step of configuring is performed automatically based on said sets of parameters.
